(19) United States
(12) Patent Application Publication
(10) Pub. No.: US 2004/0113572 A1
(43) Pub. Date: Jun. 17, 2004

(54) Control apparatus for controlling inverter for driving permanent magnet types synchronous motor

(75) Inventors: Yoshitaka Iwaji, Hitachi (JP); Tsunehiro Endo, Hitachiota (JP); Kiyoshi Sakamoto, Hitachi (JP); Tomofumi Okubo, Narashino (JP)

Correspondence Address: McDermott, Will & Emery, 600 13th Street, N.W., Washington, DC, 20005-3096, US

(73) Assignee: HITACHI, LTD., Tokyo (JP)

(21) Appl. No.: 10/729,938

(22) Filed: Dec. 9, 2003

Related U.S. Application Data
(63) Continuation of application No. 10/095,103, filed on Mar. 12, 2002.

(30) Foreign Application Priority Data
Sep. 4, 2001 (JP) 2001-267056

(51) Int. Cl. H02P 7/06

(52) U.S. Cl. 318/254

(57) ABSTRACT

An electric motor driving system has a permanent magnet type synchronous motor, an inverter for driving the motor, a generator for issuing a rotational frequency command to the motor and a controller including a conversion gain for generating a control signal to the inverter on the basis of the rotational frequency command, an integrator, a zero generator, a qc-axis voltage command arithmetic unit, a dq inverter, a dq coordinate converter, a high-pass filter, and an adder, wherein the system includes the high-pass filter for correcting the rotational frequency command to the motor on the basis of current detection values flowing through the motor, and a step-out detector for comparing the correction amount with a threshold value previously set for the coordinate amount to judge when the correction amount exceeds the threshold value at least one or more times that the motor is in the step-out state.

### BACKGROUND OF THE INVENTION

1. Field of the Invention

The present invention relates in general to a system for driving a permanent magnet type synchronous motor (PM motor). More particularly, the invention relates to the technology for detecting the step-out of an electric motor, when carrying out the control of the rotational frequency of an electric motor, without employing a sensor for detecting the speed/position of an electric motor.

2. Description of the Related Art

Heretofore, with respect to the method of detecting the step-out of a permanent magnet type synchronous motor which is driven without a sensor for detecting the speed/position of an electric motor, there is known the technology disclosed in JP-A-9-294390 and JP-A-2001-25282.

A first known example (JP-A-9-294390) is such that an effective value of a current which is caused to flow through an electric motor and a power factor are arithmetically operated to discriminate the presence or the absence of the step-out. The point that the effective value of the electric motor current is increased during the step-out and the point that the power factor is reduced during the step-out are utilized, a threshold value is set for the effective value, and the state of the electric motor is judged to be the step-out when the power factor at that time is equal to or lower than a predetermined value.

A second known example (corresponding to claim 1 of JP-A-2001-25282) is such that the electric motor current is detected to measure an A.C. cycle, and this A.C. cycle is compared with an A.C. cycle applied to the electric motor, and the state of the electric motor is judged to be the step-out when both of the A.C. cycles are different from each other. For the discrimination of the step-out, the property is utilized in which during the step-out, a current the frequency of which is different from the applied frequency is caused to flow through the electric motor.

A third known example (corresponding to claim 2 of JP-A-2001-25282) is such that the electric motor current is detected which is in turn coordinate-transformed into the rotational coordinate axes, and the presence or the absence of the step-out is discriminated on the basis of the magnitude of the current for the excitation. For the discrimination of the step-out, the property is utilized in which during the step-out, the exciting current is changed.

However, in the first known example, the method of determining the effective value of the current for use in the discrimination of the step-out is difficult, and also there is the possibility that even when the electric motor is driven in the state of the overload, the step-out is detected by mistake. In particular, in the condition of driving the electric motor with the power factor of the field system weakening region or the like being reduced, the condition setting is difficult. In addition, it is necessary to carry out the root arithmetic operation of the square root of the total sum of the phase currents squared in the arithmetic operation of the current effective value, and the processing of this arithmetic operation is difficult to be executed using a low cost controller (microcomputer).

In the second known example, in order to measure the A.C. cycle of the current, for example, it is necessary to measure a time from a zero point to a zero point of the current waveform, and hence when the A.C. cycle of the current is long, it takes time to detect the step-out. In addition, in the case where the electric motor is stopped at a stretch due to the abrupt load disturbance, since there is no difference between the applied frequency and the electric motor current, it is impossible to detect the step-out. Further, as the problem in terms of a configuration of a controller, the dedicated timer for determining the cycle of the current is required, and hence there arises the problem that the system becomes complicated.

While in the third known example, the detection of the step-out is carried out on the basis of the magnitude of the exciting current component (d-axis component) of the electric motor, since the magnitude of the exciting current is changed in the transient time during the load disturbance or the like, in this case as well, there is the possibility that the wrong detection of the step-out may be carried out. Also, since during the step-out, the difference occurs between the magnetic pole axis assumed in the controller and the true magnetic pole axis of the electric motor, the exciting current which is observed on the coordinate axes on the control side is not necessarily the proper exciting current component, and hence there is the possibility that the wrong detection of the step-out may be carried out.

In the above-mentioned first and third known examples, a point of employing the changing current effective value, power factor, exciting current or the like in the normal operation as well is a problem, and also even if any of the physical quantities is employed, the discrimination of the step-out state is difficult.

### SUMMARY OF THE INVENTION

An object of the present invention to provide a higher reliable system for driving an electric motor which is capable of carrying out surely and speedily the detection of the step-out when a permanent magnet type synchronous motor has got into the step-out state.

In order to attain the above-mentioned object, according to the present invention, there is provided an electric motor driving system for driving a permanent magnet type synchronous motor without a speed/position sensor, wherein the system is provided with the function of setting a threshold value for an arithmetic operation value of a correction amount or an axis error (axis deviation amount) to a rotational frequency command in accordance with which the physical quantity appearing characteristically only during the step-out, i.e., the electric motor control is stabilized, and of when the correction value or the axis error has become larger than the predetermined threshold value, judging that the electric motor has got into the step-out, or is provided with the function of operating arithmetically an effective power of the electric motor on the basis of the applied voltages to the electric motor and the current detection values and of discriminating the presence or the absence of the step-out of the electric motor on the basis of the arithmetic operation result.

As set forth hereinabove, according to the present invention, in an electric motor driving system for driving a permanent magnet type electric motor in the speed/position sensorless manner, it is possible to carry out surely and speedily the step-out detection when an electric motor has got into the step-out, and also it is possible to realize a higher reliable electric motor.

Other objects, features and advantages of the invention will become apparent from the following description of the embodiments of the invention taken in conjunction with the accompanying drawings.

### BRIEF DESCRIPTION OF THE DRAWINGS

The above and other objects as well as advantages of the present invention will become clear by the following description of the embodiments of the present invention with reference to the accompanying drawings, wherein:

FIG. 1 is a circuit diagram, partly in block diagram, showing a configuration of a system for driving a permanent magnet type synchronous motor according to a first embodiment of the present invention;

FIG. 2 is a schematic view showing construction of an apparatus to which the electric motor driving system of the present invention is mounted;

FIG. 3A is a vector diagram in the normal state in the first embodiment of the present invention;

FIG. 3B is a vector diagram in the overload state in the first embodiment of the present invention;

FIG. 4 is a circuit diagram showing a step-out detector in the first embodiment of the present invention;

FIG. 5 is an operation waveform diagram of the step-out detector in the first embodiment of the present invention;

FIG. 6 is a circuit diagram, partly in block diagram, showing a configuration of a second embodiment of the present invention;

FIG. 7 is a circuit diagram, partly in block diagram, showing a configuration of a third embodiment of the present invention;

FIG. 8 is a circuit diagram, partly in block diagram, showing a configuration of a fourth embodiment of the present invention;

FIG. 9 is a circuit diagram, partly in block diagram, showing a configuration of a fifth embodiment of the present invention;

FIG. 10 is a circuit diagram, partly in block diagram, showing a configuration of a sixth embodiment of the present invention;

FIG. 11 is a circuit diagram, partly in block diagram, showing a configuration of a seventh embodiment of the present invention;

FIG. 12 is a flow chart useful in explaining the control processing according to an eighth embodiment of the present invention;

FIG. 13 is an operation waveform diagram in the eighth embodiment of the present invention; and

FIG. 14 is a block diagram, partly in circuit diagram, showing a configuration of a ninth embodiment of the present invention.

### DESCRIPTION OF THE EMBODIMENTS

The embodiments of the present invention will hereinafter be described in detail with reference to the accompanying drawings.

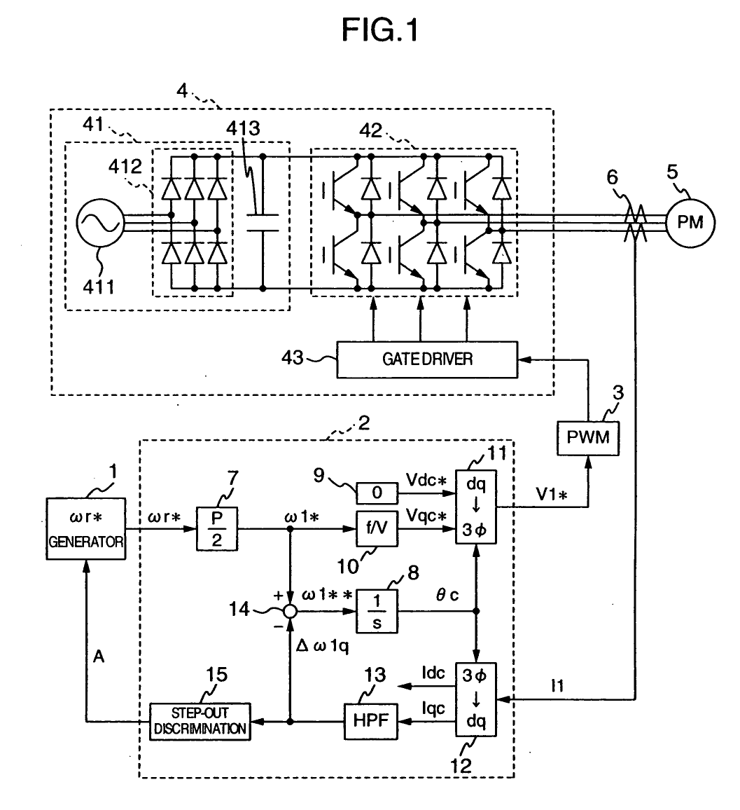

FIG. 1 is a circuit diagram, partly in block diagram, showing a configuration of a system for driving a permanent magnet type synchronous motor according to a first embodiment of the present invention. In FIG. 1, reference numeral 1 designates a speed command generator for issuing a rotational speed command ωr* to an electric motor; reference numeral 2 designates a controller for operating arithmetically applied voltages to the electric motor; reference numeral 3 designates a PWM (Pulse Width Modulated Wave) generator for generating a pulse used to drive an inverter 4 on the basis of a voltage command V1*; reference numeral 4, the inverter for driving the electric motor; reference numeral 5, a permanent magnet type synchronous motor as a subject of the control; and 6, a current detector for detecting currents of the electric motor 5.

The controller 2 includes a conversion gain (P is the number of poles of the electric motor) 7 for converting the rotational speed command ωr* to an electrical angular frequency command ω1*, an integrator 8 for operating arithmetically an A.C. phase θc in the inside of the controller on the basis of ω1*, a zero generator 9 for outputting “zero”, a qc-axis voltage command arithmetic unit 10 for operating arithmetically a voltage command Vqc* of a qc-axis component on the dc-qc-axes as the rotational coordinate axes, a dq inverter 11 for converting voltage commands Vdc* and Vqc* on the dc-axis and the qc-axis into the values on the three-phase A.C. axes, respectively, a dq-coordinate converter 12 for converting current values on the three-phase A.C. axes into components on the dc-qc-axes as the rotational coordinate axes, a high-pass filter 13 for extracting a change component of the qc-axis current component, an adder 14 for adding (subtracting) two signals, a step-out detector 15 as the characteristic part of the present invention.

The inverter 4 adapted to drive the electric motor includes a D.C. power source part 41 of the inverter constituted by an A.C. power source 411, a diode rectifier 412 and a smoothing capacitor 413, a main circuit part 42 of the inverter, and a gate driver 43 for driving the inverter main circuit 42 on the basis of a PWM signal.

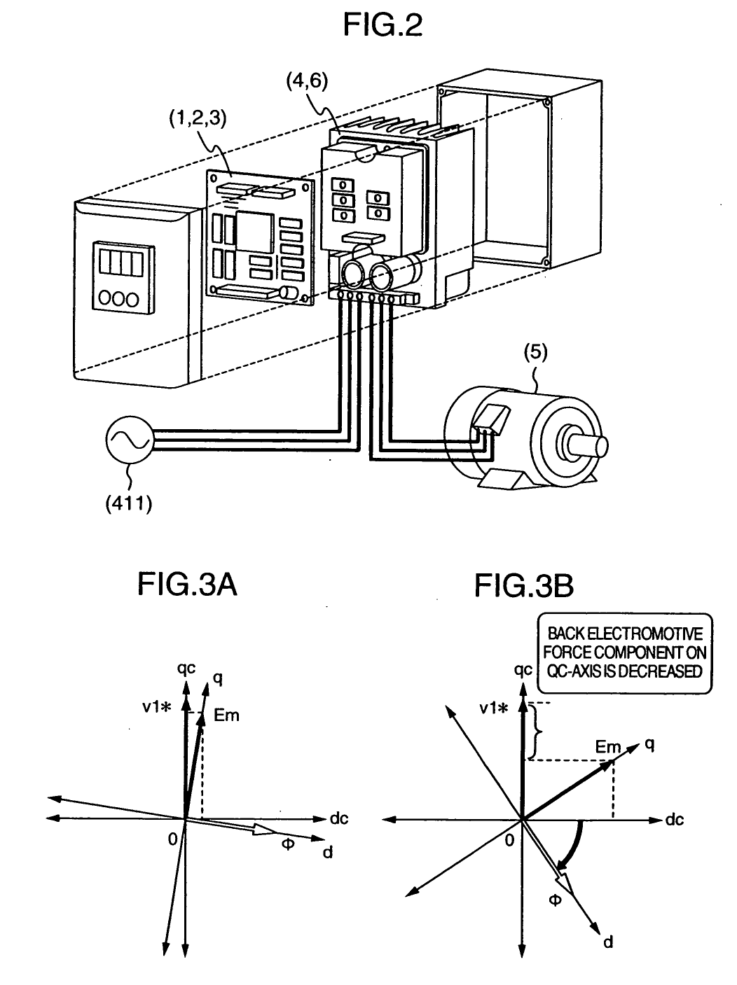

FIG. 2 shows a mounting construction view of a system for driving a permanent magnet type synchronous motor to which the present invention is applied. The system for driving an electric motor is roughly divided into the A.C. power source 411, the control/ inverter parts 1, 2, 3, 4 and 6, and the electric motor 5. As shown in FIG. 2, the function of the constituent elements designated with reference numerals 1, 2 and 3 is provided on the control board in the control/ inverter parts. In actual, the above-mentioned function is realized by the microprocessor-based digital circuit. In addition, the inverter main circuit part 4, the current detection part 6 and the like are mounted in one apparatus.

Next, the principles of the operation of the first embodiment of the present invention will hereinbelow be described with reference to FIG. 1.

The basic configuration of the present embodiment is described in JP-A-2000-236694. The electrical angular frequency ω1* of the electric motor is obtained in the form of the output signal of the conversion gain 7 on the basis of the speed command ωr*. In the phase arithmetic unit 8, electrical angular frequency ω1* is integrated, thereby obtaining the A.C. phase θc in the inside of the controller. The detection value I1 of the three-phase A.C. current is coordinate-converted using the dq coordinate converter 12 on the basis of θc, thereby obtaining Idc as the dc-axis component and Iqc as the qc-axis component. Iqc is used to compensate for ω1* through the high-pass filter 13 in order to stabilize the control system (This compensation principles will be described later). In the qc-axis voltage command arithmetic unit 10, the arithmetic operation of the qc-axis voltage command Vqc* of the electric motor is carried out on the basis of ω1*. Normally, Vdc* is set to zero. Next, Vdc* and Vqc* are coordinate-converted into the voltage command value V1* on the three-phase A.C. axis using the dq inverter 11. In the PWM generator 3, the voltage command V1* is converted into the pulse width to supply the resultant pulse signal to a gate driver 43. In the gate driver 43, the switching devices are driven on the basis of that pulse signal to apply the voltage corresponding to Vdc* and Vqc* to the electric motor 5.

Next, the description will hereinbelow be given with respect to the stabilization of the control system using Iqc (the operation of the high-pass filter 13). FIG. 3A and FIG. 3B are respectively vector diagrams when the permanent magnet type electric motor 5 is driven by the controller 2 shown in FIG. 1. The rotational coordinate axes dc-qc-axes for the control and the rotational coordinate axes d-q-axes with the magnetic pole axis of the electric motor as the reference, as shown in FIG. 3A, rotate at the same speed while having the phase deviation in the normal state. As shown in FIG. 3A, in the normal state, the applied voltage V1* to the electric motor and the induced electromotive force Em of the electric motor are roughly balanced with each other. At the moment when the load disturbance occurs, as shown in FIG. 3B, the phase difference (indicated by solid arrow lines) between the dc-qc-axes and the d-q-axes is increased, the back electromotive force component on the qc-axis is reduced, and the induced voltage component on the qc-axis is reduced. As a result, the current Iqc may be increased in an instant and also the electric motor speed may be vibrated with that instant increase as the trigger in some cases. Then, in the system described in JP-A-2000-236694, the correction of ω1* is carried out using the change rate of Iqc. In the high-pass filter 13, only the signal component for the change when Iqc is changed is extracted and the correction of ω1* is carried out with that change amount as Δω1q. As a result, the driving frequency of the electric motor is corrected in accordance with the load disturbance occurrence amount so that the deviation between the dc-qc-axes and the d-q-axes can be reduced and also the whole control system can be stabilized.

The feature of the present embodiment is that the detection of the step-out is carried out using Δω1q as the correction amount of ω1*. The principles of the operation will now be described.

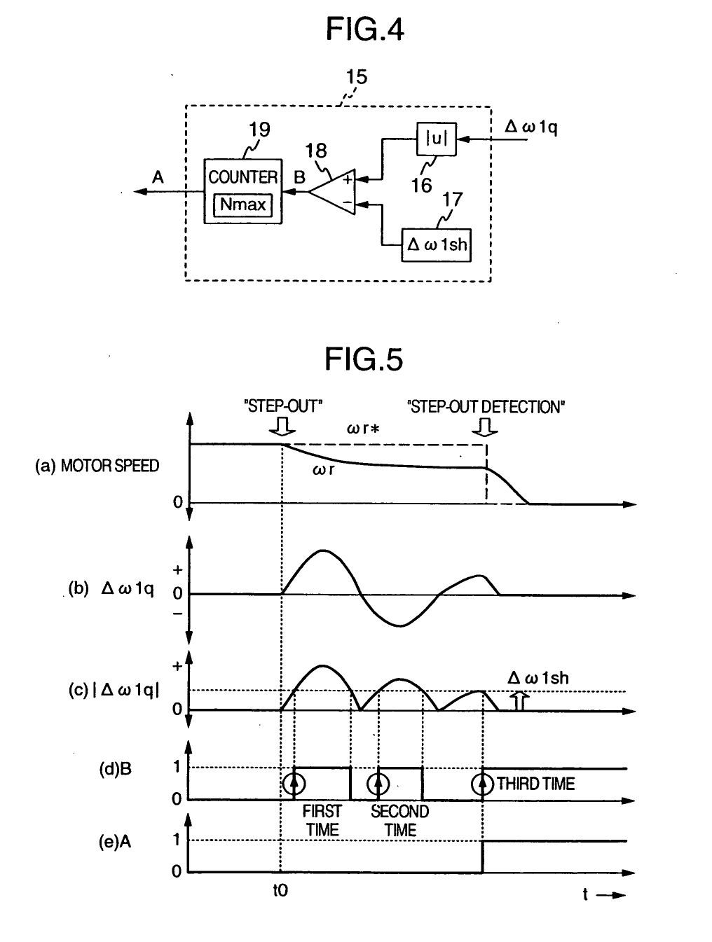

FIG. 4 shows a configuration of the step-out detector 15. The step-out detector 15 includes an absolute value arithmetic unit 16 for operating arithmetically an absolute value of Δω1q as the frequency correction amount, a step-out threshold value setting unit 17 for setting a threshold value for Δω1q, a comparator 18 for comparing two input signals, i.e., an input signal at a “+” terminal and an input signal at a “−” terminal to output “1” when the value of the input signal at the “+” terminal is larger than that of the input signal at the “−” terminal and to output “0” when the value of the input signal at the “−” terminal is larger than that of the input signal at the “+” terminal (reference symbol of this output signal is decided as B), and a counter 19 for counting the leading part of the input signal B.

By the way, the counter 19 is adapted to set the maximum value Nmax of the count value and changes the logical value of an output signal A of the counter from “0” to “1” at a time point when the number of times of leading parts of the output signal B has become equal to Nmax.

Next, the operation of the step-out detector 15 will hereinbelow be described with reference to FIG. 5. FIG. 5 shows an electric motor speed (a part(a)), Δω1q (a part (b)), the absolute value of Δω1q (a part (c)), the signal B (a part (d)) and the signal A (a part (e)) when the load disturbance occurs and the electric motor gets into the step-out.

It is assumed that at time t=t0, the load disturbance occurs and the electric motor gets into the step-out (the electric motor speed ωr does not become equal to ωr* due to the step-out). At this time, the vibration component is generated in the current Iqc which is observed on the qc-axis for the control. This results from that the d-q-axes seem to be relatively rotated with respect to the dc-qc-axes and it is observed that the qc-axis component of the back electromotive force is vibrated. As a result, the frequency correction amount Δω1q for ω1* is also vibrated to become as shown in a part (b) of FIG. 5. In the present embodiment, the detection of the step-out is carried out by utilizing the vibration component of Δω1q. Δω1q is zero in the steady state and if the state of the electric motor falls within the range of the normal load disturbance, then the vibration has the large amplitude and does not continue. Therefore, this step-out phenomenon occurs only in the abnormal state due to the step-out, and hence it is possible to discriminate surely the step-out.

In the step-out detector 15, an absolute value of Δω1q is taken and the absolute value is compared with a threshold value Δω1sh in the comparator 18 (refer to a part (c) of FIG. 5). The pulse-like signal B shown in a part (d) of FIG. 5 is outputted from the comparator 18. In the counter 19, the leading part of this pulse wave is counted. In FIG. 5, Nmax=3 is set, and a time point when the number of times of leading parts of the signal B has become 3, the logical value of the output signal A is switched from “0” to “1”. This signal A is outputted as the step-out occurrence signal from the step-out detector 15 to the outside to stop the application of the voltages to the electric motor.

By the way, the threshold value Δω1sh of Δω1q used in the step-out detection may be set by carrying out previously the drive test of the electric motor. In addition, with respect to the Nmax value (the set value for the signal A=“1”) in the counter 19, it is done beforehand to be able to set an arbitrary value equal to or higher than “1”. While the wrong detection can be reduced as the Nmax value is further increased, since it takes time to detect the step-out, the Nmax value may be set to an arbitrary value in accordance with the use of the drive of the electric motor.

As described above, if the step-out detector 15 according to the present embodiment, it is possible to extract the vibration component which occurs only in the step-out, and hence it is possible to realize the reliable step-out detection.

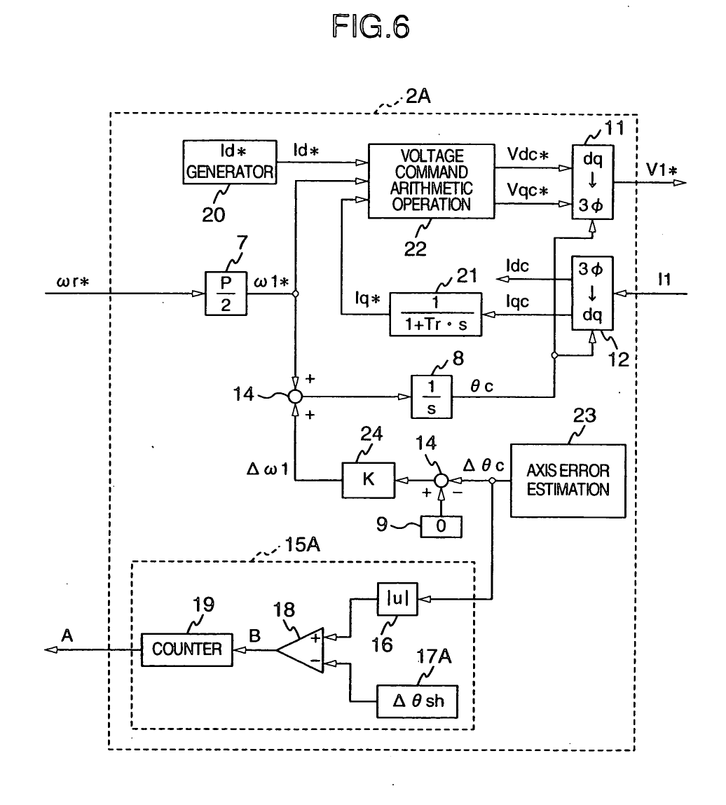

FIG. 6 shows a second embodiment of the present invention.

As for the method of driving the permanent magnet type synchronous motor in the speed/position sensorless manner, there is known the sensorless/vector control method. In the case of the sensorless/vector control method, the d-q axes with the magnetic pole axis of the electric motor as the reference matches stationarily the dc-qc-axes in the controller, and hence it is possible to realize the linearity, the optimization of the efficiency, and the like. The second embodiment of the present invention relates to the step-out detection in this sensorless/vector control method.

FIG. 6 shows a configuration of the sensorless/vector controller having the step-out detector provided therein. A controller 2A shown in FIG. 6 is employed instead of the controller 2 shown in FIG. 1, whereby it is possible to realize the second embodiment of the present invention.

In FIG. 6, the constituent elements designated with reference numerals 7 to 9, 11, 12, 14, 16, 18 and 19 are the same as those designated with the same reference numerals in the first embodiment shown in FIG. 1. Reference numeral 20 designates a d-axis current command generator for generating a d-axis current command Id*, reference numeral 21 designates a q-axis current command generator for generating a q-axis current command Iq* on the basis of Iqc, reference numeral 22 designates a voltage command arithmetic unit for operating arithmetically applied voltage commands Vdc* and Vqc* of the electric motor, 23 designates an axis error arithmetic unit for estimating and operating arithmetically an axis error Δθ between the dc-qc-axes and the d-q-axes, and 24 designates a control gain for operating arithmetically a correction amount to a frequency command.

The step-out detector 15A in the sensorless/ vector control includes an absolute value arithmetic unit 16 for operating arithmetically an absolute value of the axis error Δθ, a step-out threshold value setting unit 17A for giving a threshold value to the axis error Δθ, a comparator 18 and a counter 19.

While for the sensorless/vector control method of the permanent magnet type synchronous motor, a large number of techniques have been proposed, in the present embodiment, the method of estimating directly and operating arithmetically the axis error Δθ between the coordinate axes dc-qc-axes in the inside of the controller (the magnetic pole axis is assumed to be the dc-axis) and the coordinate axes d-q-axes in the inside of the actual electric motor to control the axis error Δθ to zero (for example, refer to an article of THE PAPERS OF JOINT TECHNICAL MEETING ON SEMICONDUCTOR POWER CONVERTER AND INDUSTRY ELECTRICAL AND ELECTRIC APPLICATION, IEE Japan, No. SPC-00-67, entitled “Position Sensorless Control of IPM Motor by Direct Estimation of Axis Error”, and hereinafter, this article is decided as an article 1) is made the subject.

Next, the description will hereinbelow be given with respect to the basic operation of the second embodiment of the present invention with reference to FIG. 6.

Current commands Id* and Iq* for the electric motor are respectively operated arithmetically in the Id* generator 20 and the Iq* generator 22. While Id* is normally controlled to zero in the non-salient pole type electric motor, when carrying out the field system weakening control, the efficiency maximizing control and the like in the salient-pole type electric motor, the command other than zero may be given in some cases. While Iq* is normally obtained from the output signal of the speed controller in many cases, in the present embodiment, in terms of the expediency of the control, the detection value of Iqc is inputted to the filter to obtain Iq*.

The voltage command arithmetic unit 22 operates arithmetically the applied voltages Vdc* and Vqc* on the basis of those current commands Id* and Iq*, and ω1*. The operation Expression is expressed as follows.

V_{dc}*=R·I_{d}*−ω₁*L_{q}·I_{q}*

V_{qc}*=ω₁*·L_{d}·I_{d}*+R·I_{q}*+Kₑ*ω₁* . . . (Expression 1)

where R is an electric motor resistance, Ld is a d-axis inductance, Lg is a q-axis inductance and Ke is a generating constant of an electric motor.

The axis error arithmetic unit 23 operates arithmetically the axis error estimate Δθc between the dc-qc-axes and the d-q-axes on the basis of the current detection values Idc and I qc. According to the above-mentioned article 1, the operation Expression for Δθc is expressed as follows.

$$Δ {θ}_{c} = {tan}^{- 1} \frac{{V}_{d c}^{*} - R \cdot {I}_{d c} + {ω}_{1}^{*} {L}_{q} \cdot {I}_{q c}}{{V}_{q c}^{*} - R \cdot {I}_{q c} + {ω}_{1}^{*} {L}_{q} \cdot {I}_{d c}} \qquad ( Expression 2 )$$

In order to control Δθc to zero, the correction of ω1* is carried out through the control gain 24. The control response to Δθc is determined by the control gain 24.

If the state falls within the normal load disturbance, then Δθc is increased simultaneously with the occurrence of the load disturbance, and ω1* is corrected on the basis thereof so that Δθc converges to zero within a fixed period of time (within a response time determined by the control gain 24). On the other hand, in the case where the load disturbance beyond the suppression occurs, it is impossible to make the axis error zero, and as a result, the state of the electric motor gets into the step-out. However, since Expression 2 is established even in the step-out, it is observed that the axis error Δθc is vibrated within the range of ±180 degrees.

In the present embodiment, the detection of the step-out is carried out by utilizing the vibration of Δθc .

In the step-out detector 15A, Δθc is inputted, and in the absolute value arithmetic unit 16, the absolute value of Δθc is arithmetically operated. Also, the absolute value of Δθc is compared with a step-out threshold Δθsh which is previously set in a step-out threshold value setting unit 17A in the comparator 18. Thereafter, the pulse signal B of the comparison result is counted in the counter 19 to discriminate the presence or the absence of the step-out. The operation on and after the operation in the comparator is the same as that shown in FIG. 5.

The step-out detector 15A of the present embodiment has the merit that the step-out threshold level Δθsh can be readily set. In the case of the permanent magnet type synchronous motor, while if the axis error falls within ±90 degrees, the state thereof is stable, if the axis error exceeds that range, then the electric motor itself becomes unstable so that the electric motor gets into the step-out. Therefore, Δωsh may be set to about 90 degrees (for example, 85 degrees or the like from the margin), and also the level setting based on the practical motor test or the simulation analysis is unnecessary. As a result, it is possible to detect surely the step-out without the wrong detection.

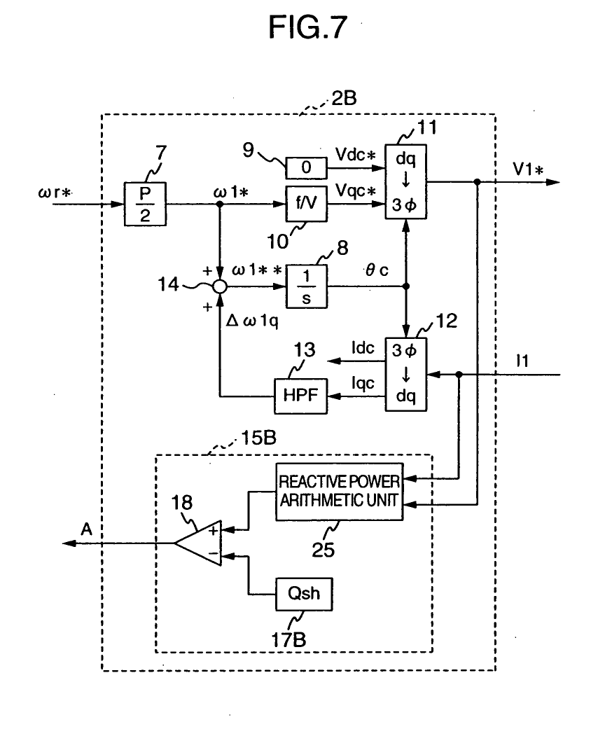

FIG. 7 shows a third embodiment of the present invention.

Though since in the above-mentioned first and second embodiments, the step-out detection is carried out using Δω1q and Δθc which are changed in the step-out, the certainty of the step-out discrimination is enhanced, there arises the following problem. That is, when the load disturbance is very large and hence the rotation of the electric motor is stopped in an instant, the back electromotive force of the electric motor becomes zero at a stretch so that the vibration phenomenon of the above-mentioned Δω1q or Δθc does not occur. In other words, the above-mentioned first and second embodiments are not suitable for the use in which the electric motor gets into the step-out by the abruptly applied load to be stopped. In the third embodiment of the present invention, the step-out detecting method with which the above-mentioned problem is solved is provided.

In FIG. 7, the constituent elements designated with reference numerals 7 to 14 and 18 are the same as those designated with the same reference numerals in the first embodiment shown in FIG. 1. Reference numeral 2B designates a controller which is employed instead of the controller 2 in FIG. 1, whereby it is possible to realize the electric motor driving system which is capable of even when the electric motor is stopped, detecting surely the step-out.

The step-out detector 15B includes a step-out threshold value setting unit 17 for giving a threshold value to the reactive power, a reactive power arithmetic unit 25 for operating arithmetically the reactive power on the basis of the voltage command V1* and the current detection value I1 of the electric motor, and a comparator 18.

Next, the description will hereinbelow be given with respect to the principles of the operation of the third embodiment of the present invention with reference to FIG. 7.

While the controller 2B of the present embodiment is basically operated in the same manner as that in the controller 2 in FIG. 1, it includes the step-out detector 15B. The reactive power arithmetic unit 25 operates arithmetically the reactive power of the electric motor. The reactive power is compared with a threshold value θsh of the step-out threshold value setting unit 17B to discriminate the presence or the absence of the step-out.

In the case of the permanent magnet type synchronous motor, the effective power is the predominant power in the range of the normal operation and hence the reactive power is hardly generated. However, since in the state of stopping the step-out, the back electromotive force of the electric motor becomes zero, all of the applied voltages to the electric motor are necessarily applied to the inductances (Ld and Lq) of the electric motor. As a result, the reactive power is abruptly increased. Therefore, the reactive power is the physical quantity which characteristically appears only when the electric motor is in the step-out state, and hence it is very effective to use the reactive power in the discrimination of the step-out detection.

The arithmetic operation for the reactive power is carried out in accordance with the following Expression.

The voltage commands V1* (=Vu*, Vv*, Vw*) and the current detection values I1 (=Iu, Iv, IW) are transformed into the values on the stator coordinate α-β axes.

$$\begin{matrix}[ \begin{matrix}{V}_{α} \\ {V}_{β}\end{matrix} ] = \frac{2}{3} [ \begin{matrix}1 & - \frac{1}{2} & - \frac{1}{2} \\ 0 & \frac{\sqrt{3}}{2} & - \frac{\sqrt{3}}{2}\end{matrix} ] [ \begin{matrix}\begin{matrix}{V}_{u}^{*} \\ {V}_{v}^{*}\end{matrix} \\ {V}_{w}^{*}\end{matrix} ] & ( Expression 3 ) \\ [ \begin{matrix}{I}_{α} \\ {I}_{β}\end{matrix} ] = \frac{2}{3} [ \begin{matrix}1 & - \frac{1}{2} & - \frac{1}{2} \\ 0 & \frac{\sqrt{3}}{2} & - \frac{\sqrt{3}}{2}\end{matrix} ] [ \begin{matrix}\begin{matrix}{I}_{u} \\ {I}_{v}\end{matrix} \\ {I}_{w}\end{matrix} ] & ( Expression 4 )\end{matrix}$$

When the above-mentioned V_{α}, V_{β} and I_{α}, I_{β} are used, the reactive power Q is expressed by the following Expression.

$$Q = \frac{3}{2} ( {V}_{β} {I}_{α} - {V}_{α} {I}_{β} ) \qquad ( Expression 5 )$$

Expression 3 to Expression 5 are calculated by only the arithmetic operation of the sum of products, and hence a period of time required to carry out the arithmetic operation processing is short. By the way, while the voltage command V1* is used in the arithmetic operation of the reactive power Q, even if the voltage detection value is used, there is no problem.

While in the first known example, the step-out is discriminated in the two steps on the basis of the magnitude of the current effective value and the magnitude of the power factor, if the reactive power is used, then the detection of the step-out can be carried out only by the discrimination in one step. Thus, the wrong detection is reduced and hence the detection speed is also increased. Though in the third known example, the discrimination of the step-out is carried out on the basis of the exciting current component viewed from the control axis of the electric motor, in the state of the step-out axis drift, the exciting current does not match necessarily the actual reactive component of the electric motor in some cases. In addition, even when the state of the electric motor falls within the range of the normal operation, there is also the possibility that the exciting current is changed due to the transient phenomenon such as the torque change to carry out the wrong detection. However, since the reactive power is the physical quantity which is increased only in the step-out, it is possible to detect surely the step-out.

While the set value of the step-out threshold value setting unit 17B can be determined on the basis of the practical motor test, it is also possible that the reactive power in the step-out is supposed and operated arithmetically from the electric motor constant to be previously set. By the way, the third embodiment shown in FIG. 7, unlike the above-mentioned first and second embodiments, the output signal of the comparator 18 is outputted in the form of the step-out detection signal to the outside as it is. When the reactive power is utilized, since the certainty of the discrimination of the step-out is enhanced, it is unnecessary to add the counter.

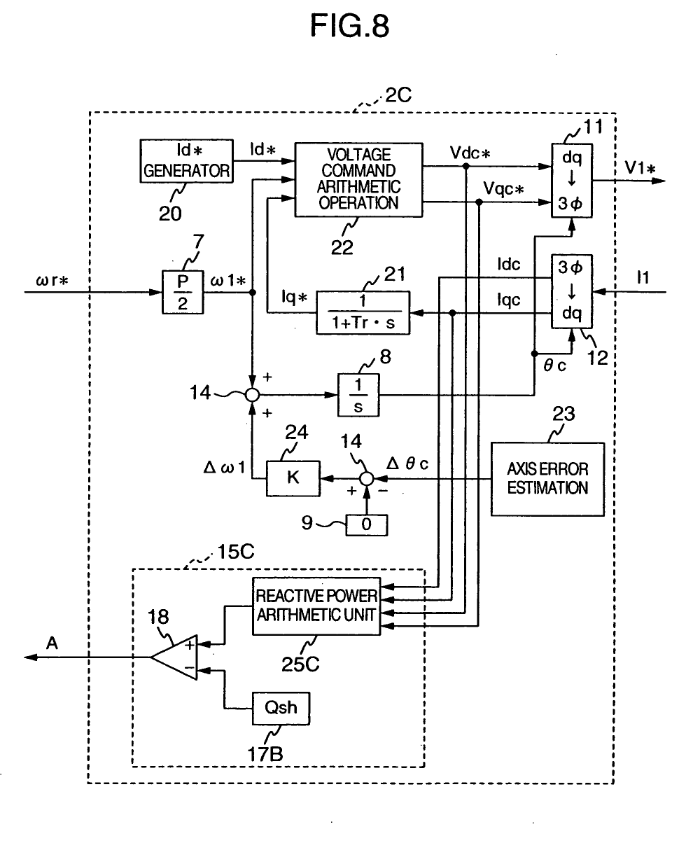

FIG. 8 shows a fourth embodiment of the present invention.

In the above-mentioned third embodiment of the present invention, the reactive power is operated arithmetically using the A.C. voltages and the A.C. currents of the electric motor, and hence the third embodiment can be applied to the electric motor driving system based on any of the control methods as long as that configuration is adopted. However, since in the controller for realizing the sensorless/vector control and the like, it is possible to operate arithmetically the reactive power more simply, the embodiment associated therewith will now be described.

In FIG. 8, the constituent elements designated with reference numerals 7 to 9, 11, 12, 14, 17B, 18 and 20 to 24 are the same as those designated with the same reference numerals in the above-mentioned first to third embodiment. Reference numeral 2C designates a controller. The controller is employed instead of the controller 2 shown in FIG. 1, whereby it is possible to realize the electric motor driving system according to the fourth embodiment of the present invention.

A step-out detector 15C includes a reactive power arithmetic unit 25C for operating arithmetically the reactive power on the basis of the voltage commands Vdc* and Vqc*, and the current detection values Idc and Iqc of the electric motor, a step-out threshold value setting unit 17B for giving a threshold value to the reactive power, and a comparator 18.

The basic operation of the present embodiment is the same as that of the sensorless/vector controller shown in FIG. 6. While a configuration of the step-out detector 15C is roughly the same as that of the step-out detector 15B shown in FIG. 7, the method of operating arithmetically the reactive power is different therefrom.

In the present embodiment, Vdc*, Vqc* and Idc, Iqc as the values on the dc-qc-axes are used in the arithmetic operation of the reactive power. In the reactive power arithmetic unit 25C, the arithmetic operation of the reactive power Q is carried out in accordance with the following Expression.

$$Q = \frac{3}{2} ( {V}_{q c}^{*} {I}_{d c} - {V}_{d c}^{*} {I}_{q c} ) \qquad ( Expression 6 )$$

As shown in Expression 6, the arithmetic operation of the reactive power can be realized on the basis of the arithmetic operation of the simple sum of products. With respect to the arithmetic operation of the reactive power, the coordinate axes do not necessarily match the actual d-q-axes, and hence even if what kind of observation axes are adopted, in principle, the accurate values can be arithmetically operated.

Therefore, in the present embodiment, even if the reactive power is arithmetically operated on the coordinate axes dc-qc-axes within the controller, the accuracy itself of the arithmetic operation of the reactive power is not degraded. In addition, Vdc*, Vqc* and Idc, Iqc as the state quantities of the inside of the controller are employed, which results in that it is possible to realize the step-out detection by the simple arithmetic operation.

The result of the arithmetic operation made by the reactive power arithmetic unit 25C is compared with the threshold value of the step-out threshold value setting unit 17B to discriminate the presence or the absence of the step-out.

As described above, according to the fourth embodiment of the present invention, it is possible to realize surely the step-out detection by the simple arithmetic operation.

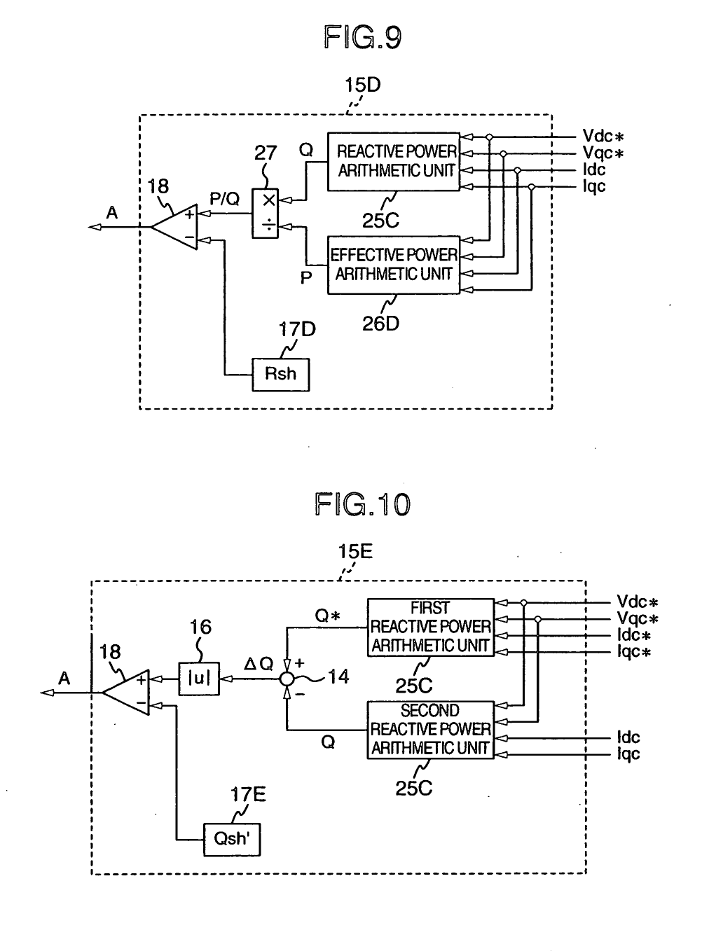

FIG. 9 shows a fifth embodiment of the present invention.

In the above-mentioned third and fourth embodiments, even if the electric motor is in the step-out stop state, the step-out can be surely detected. However, it may safely be said that it is the problem that how Qsh as the step-out detection level is set. While Qsh can be obtained by the arithmetic operation based on the practical motor test or the electric motor constants, in the practical motor test, it is necessary to carry out the test for the various electric motors and the operation conditions thereof, and hence it can not be said that the practical motor test is the simple method. In addition, in the case as well where Qsh is obtained by the arithmetic operation, there is the possibility that the electric motor constants may be changed in accordance with the condition, and hence the insecure factor remains. In the present embodiment, the step-out detection method with which those problems are solved is provided.

In FIG. 9, the constituent elements designated with reference numerals 25C and 18 are the same as those designates with the same reference numerals in the fourth embodiment in FIG. 8. A step-out detector 15D includes a step-out threshold value setting unit 17D for setting a step-out threshold value on the basis of the ratio of the reactive power to the effective power, an effective power arithmetic unit 25D for operating arithmetically an effective power, which is consumed by the electric motor, on the basis of Vdc*, Vqc* and Idc, Iqc, a divider 27 for outputting the result which has been obtained by dividing an input signal at a terminal indicated by “x” by an input signal at a terminal indicated by “÷” a reactive power arithmetic unit 25C for operating arithmetically a reactive power on the basis of the voltage commands Vdc*, Vqc* and the current detection values Idc, Iqc of the electric motor, and a comparator 18.

The step-out detector 15D shown in FIG. 9 is employed instead of the step-out detector 15C shown in FIG. 8, whereby it is possible to realize the fifth embodiment of the present invention.

In the permanent magnet type synchronous motor, in the normal operation, the electric motor is driven in the state in which the effective power is larger than the reactive power. As described above, since during the step-out, almost the applied voltages to the electric motor is applied to the inductances of the electric motor, the effective power is decreased, while the reactive power is increased. Therefore, if this property is utilized, then it is possible to detect surely the step-out and also the level for the step-out threshold value becomes easy to be set.

In the reactive power arithmetic unit 25C shown in FIG. 9, the arithmetic operation of the reactive power Q is carried out in accordance with Expression 6. In the effective power arithmetic unit 26D, the reactive power P is arithmetically operated in accordance with the following Expression.

$$P = \frac{3}{2} ( {V}_{d c}^{*} {I}_{d c} - {V}_{q c}^{*} {I}_{q c} ) \qquad ( Expression 7 )$$

The ratio of the reactive power to the effective power is obtained in the divider 27, and the result thereof is compared with a threshold value Rsh of the setting unit 17D to discriminate the presence or the absence of the step-out. The threshold value Rsh may be set to the range of about 1 to about 3.

As described above, according to the fifth embodiment of the present invention, it is possible to provide the step-out detection in which the setting of the step-out threshold value is easy. By the way, the present embodiment is allowed to be realized on the A.C. coordinate axes as shown in FIG. 8.

FIG. 10 shows a sixth embodiment of the present invention.

Each of the above-mentioned third to fifth embodiments of the present invention is such that the step-out detection is carried out on the basis of the magnitude of the reactive power which becomes remarkable in the step-out. In the case of the non-salient pole type permanent magnet synchronous motor, the reactive power is small in the normal operation range, and hence there is no problem in the above-mentioned embodiments. However, in the non-salient pole type permanent magnet synchronous motor, the field system weakening control may be carried out in the high speed range in some cases. In such cases, even if the operation is in the normal operation range, the reactive power is generated. Therefore, when each of the above-mentioned embodiments is implemented as it is, there is the possibility that the wrong detection is carried out for the step-out.

In the sixth embodiment shown in FIG. 10, the step-out detection method with which the above-mentioned problem is solved is provided. In FIG. 10, the constituent elements designated with reference numerals 14, 16, 18 and 25C are the same as those designated with the same reference numerals in the above-mentioned embodiments. A step-out detector 15E includes a first reactive power arithmetic unit 25C for operating arithmetically a first reactive power on the basis of the voltage commands Vdc*, Vqc* and the current commands Id*, Iq*, a second reactive power arithmetic unit 25C′ for operating arithmetically a second reactive power on the basis of the voltage commands Vdc*, Vqc* and the current detection values Idc, Iqc, a step-out threshold value setting unit 17E for setting a step-out threshold level on the basis of a reactive power error, an adder 14, an absolute value arithmetic unit 16 and a comparator 18.

Next, the operation of the present embodiment will hereinbelow be described. The step-out detector 15E shown in FIG. 10 includes the two reactive power arithmetic units which operate arithmetically the first and second reactive powers on the basis of the current commands Id*, Iq* and the current detection values Idc, Iqc, respectively. The reactive power when the current commands are employed is expressed as follows and it is decided as the reactive power command Q*.

$${Q}^{*} = \frac{3}{2} ( {V}_{q c}^{*} {I}_{d c}^{*} - {V}_{d c}^{*} {I}_{q c}^{*} ) \qquad ( Expression 6 )$$

In the normal operation range, Q* becomes the value near zero, while in the field system weakening range, Q* has a value. Since during the step-out, the deviation between Q* and the actual reactive power Q becomes large, the detection of the step-out is carried out by utilizing that value.

A step-out detection threshold level Qsh′ is previously set in the step-out threshold value setting unit 17E. By the way, while in the present embodiment, the deviation between Q* and Q is obtained in the adder 14 to be compared with the step-out threshold value Qsh′, as in the fifth embodiment shown in FIG. 9, even when the ratio of Q to Q* is obtained, there is no problem.

As described above, according to the sixth embodiment of the present invention, it is possible to provide the electric motor driving system which is capable of detecting surely the step-out without the wrong detection even in the field system weakening range.

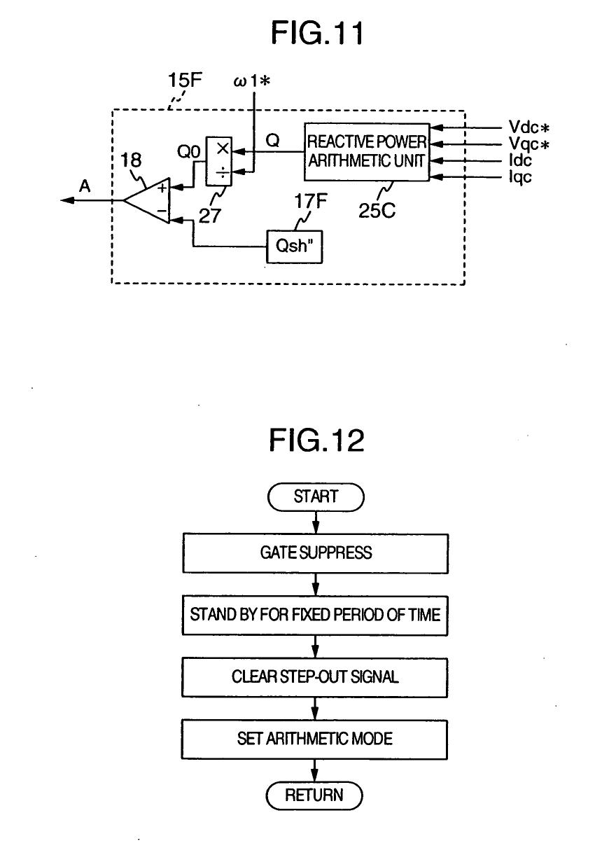

FIG. 11 shows a seventh embodiment of the present invention.

In the above-mentioned embodiments until now, the step-out detecting method utilizing the reactive power is such that the magnitude of the reactive power is compared with a certain threshold level to discriminate the presence or the absence of the step-out. However, the magnitude of the reactive power depends on the frequency applied to the electric motor and hence when the frequency is low, the magnitude of the reactive power has a tendency to be decreased. Therefore, there is the possibility that the wrong detection of the step-out may be carried out depending on the driving speed of the electric motor. This is a problem. In the present embodiment, a step-out detector with which the above-mentioned problem is solved is provided.

In FIG. 11, the constituent elements designated with reference numerals 18, 25C and 27 are the same as those designated with the same reference numerals in the above-mentioned embodiments until now. A step-out detector 15F includes a step-out threshold value setting unit 17F for setting a step-out threshold level, a reactive power arithmetic unit 25C for operating arithmetically the reactive power on the basis of the voltage commands Vdc*, Vqc* and the current detection values Idc, Iqc, a divider 27, and a comparator 18. The step-out detector 15F shown in FIG. 11 is employed instead of the step-out detector 15C shown in FIG. 8, whereby it is possible to realize the seventh embodiment of the present invention.

Next, the operation of the present embodiment will hereinbelow be described. In FIG. 11, the reactive power arithmetic unit 25C operates arithmetically the reactive power Q in accordance with Expression 6 on the basis of the voltage commands Vdc*, Vqc* and the current detection values Idc, Iqc. Both of Vdc* and Vqc* which are used in the arithmetic operation of the reactive power are obedient to Expression 1, and are intensely influenced by ω1*. For this reason, Q largely depends on ω1* and hence the value thereof becomes small in the region in which ω1* is small.

In the present embodiment, in order to remove the dependency of Q on ω1*, the reactive power Q is normalized with ω1* using the divider 27 to be used as the step-out discrimination signal Q0 in the step-out discrimination. A step-out threshold level Qsh″ is set in the step-out threshold value setting unit 17F with the value normalized with ω1* as the reference.

As described above, according to the present embodiment, it is possible to provide the electric motor driving system which is capable of removing the dependency of the reactive power on the driving dependency of the electric motor to be able to detect more surely the step-out.

By the way, in the case as well where the step-out detection threshold level (e.g., the output of the step-out threshold value setting unit 17F in FIG. 11) is multiplied by ω1* instead of dividing the reactive power Q by ω1*, the same effect can be equivalently obtained.

In addition, the normalization by ω1* can also be applied to other embodiments until now employing the reactive power (or the effective power).

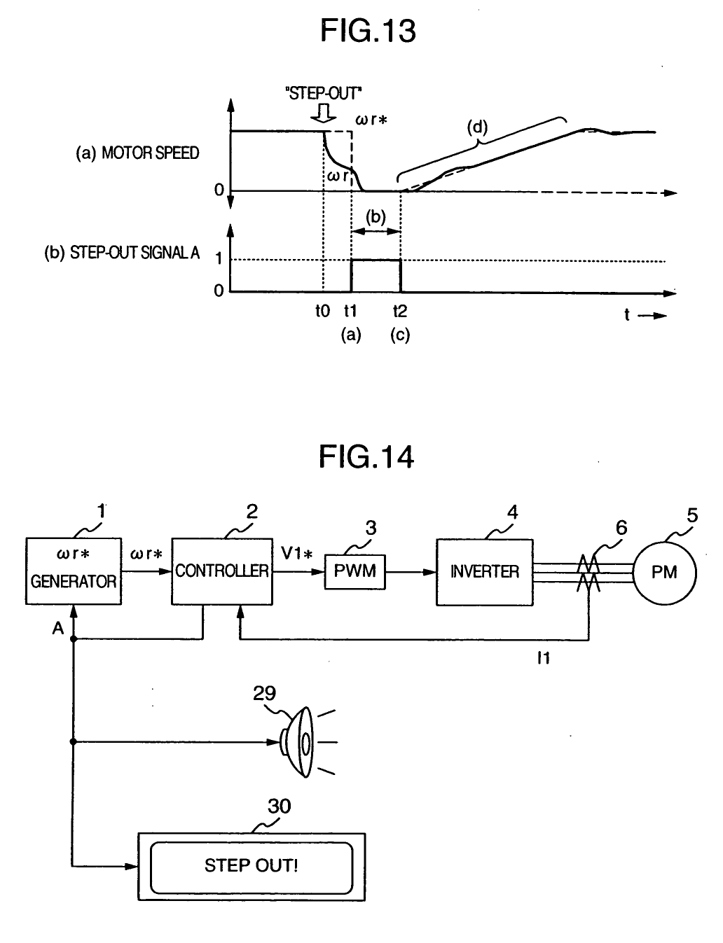

FIGS. 12 and 13 show an eighth embodiment of the present invention.

The description has been given with respect to the method of detecting the step-out in the above-mentioned embodiments. In the eighth embodiment, the description will hereinbelow be given with respect to the processing of reactivating the electric motor driving system after detection of the step-out.

A flow chart shown in FIG. 12 shows the processing routine after detection of the step-out. After having discriminated the step-out in accordance with any one of the step-out detecting system in the above-mentioned embodiments, the process branches off to lead to the step-out processing routine in FIG. 12 in which this processing is executed. First of all, all of the switching devices in the main circuit part in the inverter 4 are turned OFF (gate suppress) to separate electrically the controller and the electric motor from each other. Thereafter, after having stood by for a fixed period of time, the step-out detection signal is cleared to set the activation mode again to return the process back to the normal processing.

Operation waveforms of a series of these processings are shown in FIG. 13. In FIG. 13, the step-out occurs at a time t=t0, and the electric motor starts the deceleration. In the controller, at a time t=t1, the step-out is discriminated so that the logical value of the step-out signal A is changed from “0” to “1”. In the controller, the electric motor is electrically separated from the inverter (gate suppress), and after a lapse of a fixed period of time, at a time t=t2, the step-out signal A is cleared to reactivate the electric motor. Thereafter, the process is returned from the step-out processing routine back to the normal routine to accelerate the electric motor up to the rotational speed right before the step-out.

The above-mentioned processings are incorporated in the controller, whereby it is possible to realize the processing in which the process is returned automatically from the occurrence of the step-out back to the rotational speed. These control processings, for example, may be incorporated in the software processing in the speed command generator 1 shown in FIG. 1.

FIG. 14 shows a ninth embodiment of the present invention.

While in the above-mentioned embodiments until now, the method of detecting the step-out and the reactivation method after detection of the step-out are embodied, in the present embodiment, the function of informing a user or the like surrounding the electric motor driving system of the occurrence of the step-out is realized.

In FIG. 14, the constituent elements designated with reference numerals 1 to 6 are the same as those designated with the same reference numerals in the above-mentioned embodiments. Reference numeral 29 designates an alarm sound speaker for generating an alarm sound on the basis of the step-out signal A, and reference numeral 30 designates a display unit for displaying thereon on the basis of the step-out signal A that the electric motor 5 is in the step-out state.

As described in the above-mentioned embodiments, at the time when the step-out occurs, the logical value of the step-out signal A is changed from “0” to “1”. In the alarm sound generator 29, the alarm sound is generated by utilizing the step-out signal A to inform users surrounding the electric motor driving system of the occurrence of the step-out. At the same time, it is displayed on the display unit 30 that the step-out has occurred.

As a result, a user of the electric motor driving system can recognize without delay that the step-out has occurred. By the way, in the case where a user of the electric motor driving system does not stand by the circumference thereof, it is also possible that a user is informed of the occurrence of the step-out through the network communication or the radio communication.

It should be further understood by those skilled in the art that the foregoing description has been made on embodiments of the invention and that various changes and modifications may be made in the invention without departing from the spirit of the invention and the scope of the appended claims.

What is claimed is:

1. A system for driving an electric motor including a permanent magnet type synchronous motor, an inverter for driving said electric motor, means for issuing a rotational frequency command to said electric motor, and means for generating a control signal to said inverter on the basis of the rotational frequency command, said system comprising:
means for correcting the rotational frequency command to said electric motor on the basis of detection values of currents which are caused to flow through said electric motor; and
means for comparing the correction amount with a threshold value which is previously set for the correction amount to judge when the correction amount exceeds the threshold value at least one or more times that said electric motor is in the step-out state.

2. A system for driving an electric motor including a permanent magnet type synchronous motor, an inverter for driving said electric motor, means for issuing a rotational frequency command to said electric motor, and means for generating a control signal to said inverter on the basis of the rotational frequency command, said system comprising:
means for operating arithmetically an A.C. phase with a magnetic pole axis of said electric motor as the reference;
means for detecting values of currents which are caused to flow through said electric motor;
means for estimating and operating arithmetically an axis error between the A.C. phase and the actual magnetic pole axis phase in said electric motor using the current detection values; and
means for comparing the axis error with a threshold value which is previously set for the axis error to judge when the axis error exceeds the threshold value at least one or more times that said electric motor is in the step-out state.

3. A system for driving an electric motor including a permanent magnet type synchronous motor, an inverter for driving said electric motor, means for issuing a rotational frequency command to said electric motor, and means for generating a control signal to said inverter on the basis of the rotational frequency command, said system comprising:
means for operating arithmetically a reactive power of said electric motor; and
means for discriminating the step-out of said electric motor on the basis of the magnitude of the reactive power.

4. A system for driving an electric motor including a permanent magnet type synchronous motor, an inverter for driving said electric motor, means for issuing a rotational frequency command to said electric motor, and means for generating a control signal to said inverter on the basis of the rotational frequency command, said system comprising:
means for detecting currents which are caused to flow through said electric motor, observing the detection values on the rotational coordinate axes with an arbitrary axis as the reference, and operating arithmetically a reactive power of said electric motor on the basis of the voltage commands on the coordinate axes or voltage detection values on the coordinate axes to discriminate the step-out of said electric motor on the basis of the magnitude of the reactive power.

5. A system for driving an electric motor according to claim 3, further comprising means for operating arithmetically an effective power simultaneously with the arithmetic operation of the reactive power to discriminate the step-out of said electric motor on the basis of the ratio of the reactive power to the effective power.

6. A system for driving an electric motor including a permanent magnet type synchronous motor, an inverter for driving said electric motor, means for issuing a rotational frequency command to said electric motor, means for operating arithmetically A.C. phases with the magnetic pole axis of said electric motor as the reference on the basis of the rotational frequency command, means for generating current commands of axis components with the magnetic pole axis as a dc-axis and with the axis intersecting perpendicularly the dc axis as a qc-axis, means for operating arithmetically voltage commands of axis components on the basis of the current commands, and means for generating a control signal to said inverter on the basis of the voltage commands and the A.C. phases, said system comprising:
means for detecting currents which are caused to flow through said electric motor;
means for coordinate-converting the detection values into the dc-qc-axes components;
means for operating arithmetically a first reactive power on the basis of the dc-qc-axes current detection values and the voltage commands;
means for operating arithmetically a second reactive power on the basis of the current commands on the dc-qc-axes and the voltage commands; and
means for comparing the first and second reactive powers with each other to discriminate the step-out of said electric motor.

7. A system for driving an electric motor according to claim 3, wherein in the arithmetic operation of the reactive power(s) or the effective power used in the discrimination of the step-out of said electric motor, the individual powers or the discrimination reference of the step-out is corrected using the rotational frequency command to carry out the step-out discrimination.

8. A system for driving an electric motor according to claim 1, wherein when it is discriminated that said electric motor is in the step-out state, the application of the voltages to said electric motor is released and then said electric motor is activated again to be accelerated up to the rotational speed in the step-out.

9. A system for driving an electric motor according to claim 1, wherein when it is discriminated that said electric motor is in the step-out state, it is reported by the display, an alarm sound or electrical communication means that said electric motor is in the step-out state.
